(19) United States
(12) Patent Application Publication
(10) Pub. No.: US 2025/0313295 A1
(43) Pub. Date: Oct. 9, 2025

(54) VEHICLE WITH GEO-FENCED RIDE CONTROL SYSTEM

(71) Applicant: LAND ENERGY, INC, Cleveland, OH (US)

(72) Inventors: George Henry Remington, Bay Village, OH (US); Evan Painter, Cleveland, OH (US); Zack Simmering, Mansfield, OH (US); Scott Colosimo, Cleveland, OH (US); Garvin SETO, Cleveland, OH (US)

(73) Assignee: LAND ENERGY, INC, Cleveland, OH (US)

(21) Appl. No.: 19/243,089

(22) Filed: Jun. 19, 2025

Related U.S. Application Data
(63) Continuation-in-part of application No. 17/931,320, filed on Sep. 12, 2022.
(60) Provisional application No. 63/242,819, filed on Sep. 10, 2021.

(51) Int. Cl. B62J 50/22; B62J 43/10; B62J 45/20

(52) U.S. Cl. CPC B62J 50/22; B62J 43/10; B62J 45/20

(57) ABSTRACT

A vehicle with a Geo-Fenced Ride Control System including: one or more battery modules including one or more battery cells; one or more processors operably connected to the one or more battery cells to control vehicle performance; and a Global Positioning System (GPS) or cellular network receiver configured to determine location of the vehicle; wherein the one or more processors communicates with a remote sever to determine a plurality of available vehicle performance settings for the vehicle based on the location of the vehicle. The vehicle further includes a user input interface configured to receive user input including selection of the vehicle performance setting form the plurality of available vehicle performance settings based on the geographic location of the vehicle.

### RELATED APPLICATIONS

This application is a continuation-in-part of U.S. patent application Ser. No. 17/931,320, filed Sep. 12, 2022, and titled “VEHICLE WITH GEO-FENCED RIDE CONTROL SYSTEM,” which claims priority to U.S. Provisional Patent Application No. 63/242,819, filed on Sep. 10, 2021, and titled “BATTERY SYSTEM AND BATTERY POWERED VEHICLE.” The entirety of both is incorporated herein by reference.

### TECHNICAL FIELD

The present invention relates swappable battery packs and an associated charging port for electric vehicles, namely electric bikes (eBikes).

### BACKGROUND

Electric vehicles continue gaining traction as a means of transportation. Light electric vehicles (LEV) specifically, are gaining traction in the United States after enjoying years of popularity in Europe. Part of the appeal is the ease of ride. Most people can ride them, from the most seasoned rider to someone who has not ridden since childhood. LEV have the potential to expand riding to new audiences and keep people riding throughout their lives.

But some confusion around how and where LEV can be ridden is dampening their growth potential and as an emerging technology, they require clear regulations to govern their use and create stability in the marketplace.

In the United States, at the federal level, the National Highway and Transportation Safety Administration (NHTSA) establishes Federal Motor Vehicle Safety Standards (FMVSS) that define LEV for the purpose of product safety for manufacturing and first sale. States decide how LEV can be used on streets and bike paths. Over time, without clear guidance, states adopted diverging rules governing the use of LEV—some treating them like human-powered bicycles, some treating them like motor vehicles, and everything in between. Some states have no regulation whatsoever.

In Europe, there have been efforts at a uniform continental standard (e.g., EU directive 2002/24/EC) but, generally, the regulatory picture remains complicated. Generally, individual European countries decide how LEV can be used on their streets and bike paths and they have adopted diverging rules governing the use of LEV.

This diverging set of rules creates problems both for riders and for manufacturers. Riders who wish to follow the law often do not know what the law is in their respective location. Manufacturers wishing to enter the LEV market must contend with the limitations imposed by a varied set of rules that often impede their ability to sell products nationally, regionally, or globally.

### SUMMARY OF THE INVENTION

The principles and aspects of the present disclosure have application to light electric vehicles (LEV) regulatory management anywhere in the world. In the present disclosure, these principles are described below primarily in the context of U.S. regulation. It should be understood, however, that the principles and aspects of the present disclosure may be applicable to other regions, countries, continents, etc. as well as to other electric vehicle applications subject to governmental regulation.

Since 2014, more than 30 U.S. states have passed a standardized regulation for LEV use with an approach known as the “3-Class” System. This model legislation defines three common classes of LEV (based on speed, wattage, and operation), and allows states to decide which types of bicycle infrastructure each class can use (typically Class 1 and Class 2 eBikes are allowed wherever traditional bikes are allowed). It also requires LEV makers to highly visible indicate an LEV's Class.

In 2015, California was the first state to adopt this “3-Class” approach, and since then, 32 other states followed suit: Alabama, Arizona, Arkansas, Colorado, Connecticut, Florida, Georgia, Idaho, Illinois, Indiana, Iowa, Louisiana, Maine, Maryland, Michigan, Mississippi, New Hampshire, New Jersey, New York, North Dakota, Ohio, Oklahoma, South Dakota, Tennessee, Texas, Utah, Virginia, Vermont, Washington, West Virginia, Wisconsin, and Wyoming. As popularity of these vehicles continues to increase, more states around the country will adopt this “3-Class” standard to eliminate confusion, enhance safety, and promote this green transportation method.

The three classes are defined as follows:
Class 1: eBikes that are pedal-assist only, with no throttle, and have a maximum assisted speed of 20 mph.
Class 2: eBikes that also have a maximum speed of 20 mph but are throttle-assisted.
Class 3: eBikes that are pedal-assist only, with no throttle, and a maximum assisted speed of 28 mph.

Some states treat Class 1 eBikes like traditional mountain or pavement bicycles, legally allowed to ride where bicycles are permitted, including bike lanes, roads, multiuse trails, and bike-only paths.

Class 2 throttle-assist eBikes are often allowed most places a traditional bicycle can go, though some states and cities are opting for additional restrictions (e.g., New York City & Michigan State). Class 2 may not be suitable for singletrack mountain bike trails—it has been shown that they pose greater physical damage to trails due to the throttle-actuation. Class 2 may be better suited for multi-use OHV trails designed for more rugged off-road vehicles.

Class 3 eBikes are typically allowed on roads and on-road bike lanes (“curb to curb” infrastructure) but restricted from bike trails and multiuse paths. While a 20-mph maximum speed is achievable on a traditional bicycle, decision makers and agencies consider the greater top-assisted speed of a Class 3 eBike too fast for most bike paths and trails that are often shared with other trail users.

In addition to these classes, some LEV may be capable of performance similar to that of a traditional motorcycle, achieving speeds as high as 70-mph. The NHTSA defines additional vehicle classes applicable to higher powered LEV.

A motorcycle is defined as a motor vehicle with motive power having a seat or saddle for the use of the rider and designed to travel on not more than three wheels in contact with the ground. A motor-driven cycle is defined as a motorcycle with a motor that produces 5-brake horsepower or less. A moped is a type of motor-driven cycle whose speed attainable in 1 mile is 30 mph or less, which is equipped with a motor that produces 2 brake horsepower or less. FMVSS requires that motorcycles be equipped with footrests at each seating position. The pedals on a moped may serve as footrests even when the engine is propelling the moped.

And, again, states have adopted diverging rules governing the use of motorcycles.

Enthusiasts and manufacturers alike in the U.S. as well as in Europe and elsewhere look forward to a time when the regulatory situation improves and the rules applying to LEV are relatively uniformed across geography. In the meantime, however, riders and manufacturers alike must contend with the difficult regulatory environment.

The invention disclose herein allows a manufacturer to manufacture one vehicle. The vehicle may determine its geographical location, the time of day, live traffic conditions, and user history of the vehicle, and based on one or more of those parameters, select the applicable governing rules, ride settings, and desired vehicle behavior. The vehicle may then automatically select a driving mode based on the applicable rules, ride settings, and desired vehicle behavior. This way the rider always complies with the rules governing the geographical location, and optimizes their ride according to their specific parameters. Additionally, manufacturers may produce one product that alters its own performance depending on any of these changing factors.

### BRIEF DESCRIPTION OF THE DRAWINGS

The annexed drawings, which are not necessarily to scale, show various aspects of the invention.

FIG. 1 illustrates a schematic diagram of an exemplary geo-fenced ride control system.

FIG. 2A illustrates a block diagram of an exemplary battery module.

FIG. 2B illustrates a perspective view of an exemplary battery module.

FIG. 2C illustrates a perspective view of the exemplary battery module and a plug in base.

FIG. 3 illustrates a display for an exemplary geo-fenced ride control system.

FIG. 4 illustrates a flow chart of an exemplary method for a geo-fenced ride control system.

FIG. 5 illustrates an exemplary computing environment for a geo-fenced ride control system.

### DETAILED DESCRIPTION

The principles and aspects of the present disclosure have particular application to electric motorcycles and bicycles, and thus will be described below chiefly in this context. It is understood, however, that the principles and aspects of the present disclosure may be applicable for other electric vehicle applications.

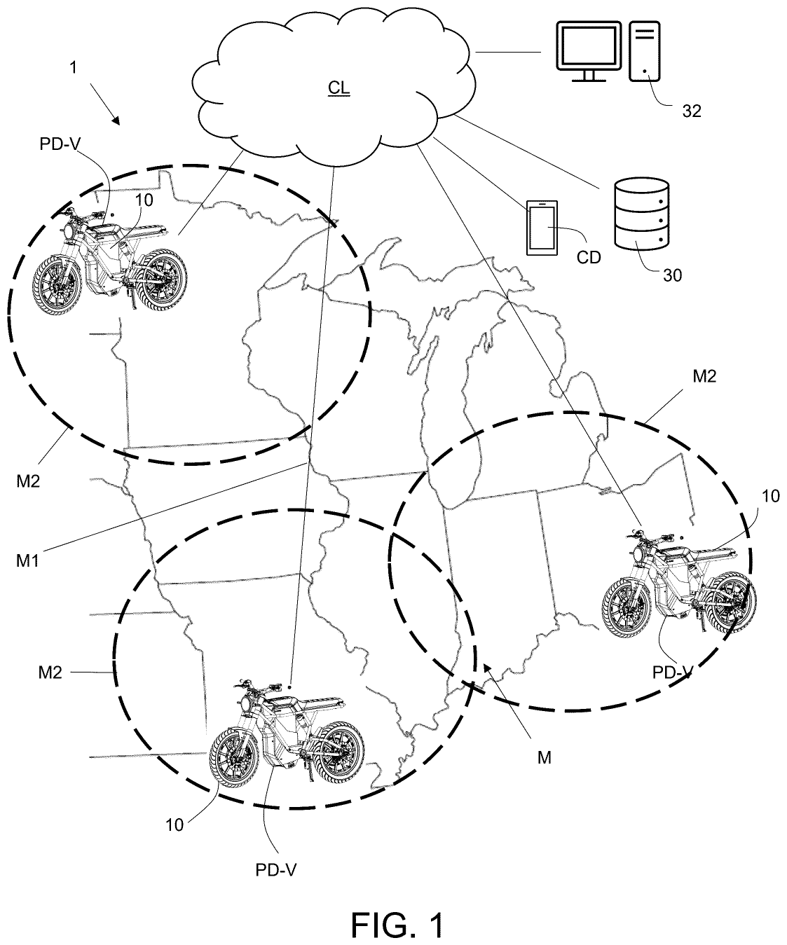

FIG. 1 illustrates a schematic diagram of an exemplary battery-centric Geo-Fenced ride modes (GF) system 1. For purposes of this disclosure, Geo-Fenced means a geographical boundary between more than one location or jurisdiction. The geographical boundary can be state-line boundaries (e.g., boundary lines M1) as shown on the map M, or may alternatively be predefined boundary lines M2 set by a user, as illustrated with the dashed boundary lines on the map M. The user may set the predefined boundary lines M2 (zones) based on their own knowledge or preference for ride conditions inside various geographical zones, and set custom user predefined ride parameters associated with a user predefined geographical zone, bounded by the predefined boundary lines M2. For example, a user may set a predefined boundary line M2 around a residential street zone and set the custom user predefined ride parameters associated with that zone to “no-turbo” or the like. The map M refers to portions of the U.S. for illustrative purposes. However, the principles and aspects described therein are applicable to other regions, countries, continents, etc. Furthermore, the same principles may be applied to other geographical divides such as county lines, municipalities, etc. The system 1 detects geographical location of a vehicle PD-V and selects the vehicle's ride/performance setting from a plurality of performance settings based on the geographical location, time of day, live traffic conditions, and/or user history. That is, based on the geographical location of the vehicle, time of day, live traffic conditions, and/or user history, an appropriate set of rules is determined, and those rules are applied to the performance or ride mode of the vehicle.

The invention, thus, allows for the manufacturing of one vehicle. The vehicle PD-V may determine its geographical location and based on that location, select the applicable rules governing its legal behavior. The vehicle PD-V may then automatically select a driving/ride mode based on the applicable rules. This way the rider always complies with the rules and manufacturers may produce one product that alters its own performance depending on where the vehicle PD-V is located at any specific time.

In either embodiment, the GF system 1, 2 may be dynamic, in that it automatically adjusts the ride settings within any given jurisdictional boundary M1 or user predefined boundary line M2 based on time of day or live traffic conditions. In this way, instead of only setting the ride settings associated based on geographical location, the ride settings may be automatically adjusted according to these other factors. For example, in a defined geographical location, whether it be a jurisdictional boundary M1 or a user predefined boundary M2, the ride settings may be adjusted to limit a speed to a certain speed between the hours of 8 am and 5 pm, for example in a business district, and revert to normal speed control outside of this time range. As another example, during congested live traffic conditions in a defined boundary M1, M2, the ride settings may lower the torque to save battery. Additionally, in either embodiment, the GF system 1, 2 may use machine learning to predictively optimize ride settings based on user history, behavior and preferences, such as typical ride routes.

Each vehicle PD-V may be powered by a battery module 10. The GF system 1 is referred herein as battery-centric because battery modules 10 allow for the construction of the GF system 1, as described in detail below.

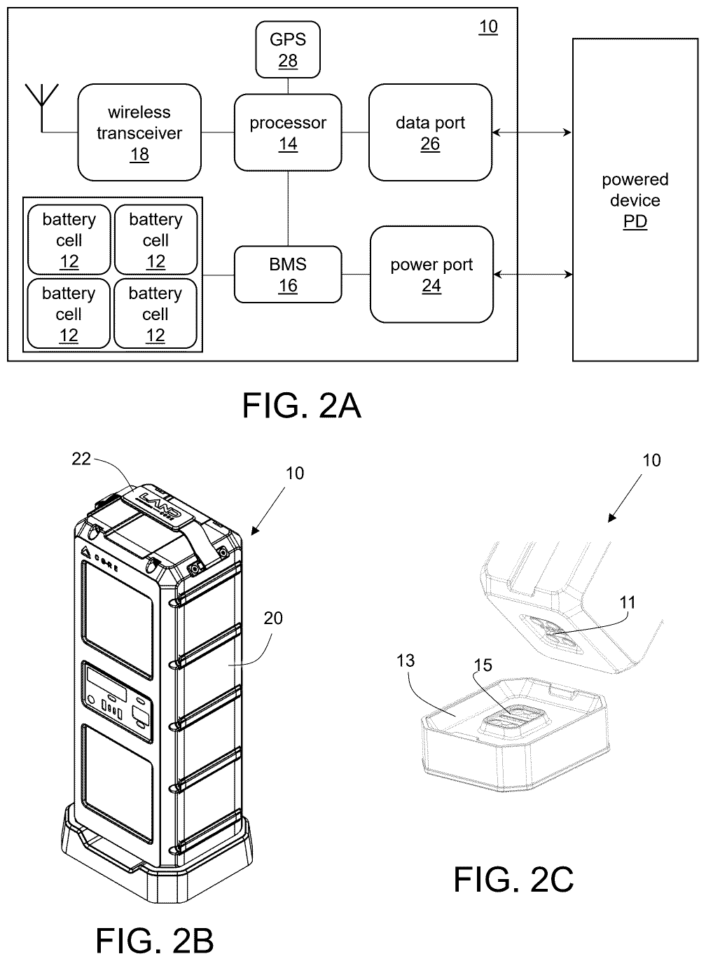

FIGS. 2A-2C illustrate a block diagram and profile views of an exemplary battery module 10. The battery module 10 may include one or more battery cells 12, one or more module processors 14, a battery management system (BMS) 16, a wireless transceiver 18, a power port 24, and a data port 26. The battery module may also include an enclosure 20 for at least partially housing the one or more battery cells 12, one or more module processors 14, battery management system (BMS) 16, wireless transceiver 18, power port 24, and data port 26.

The battery module 10 may include the one or more battery cells 12 electrically organized to enable delivery of targeted range of voltage and current for a duration of time against expected load scenarios. The number and capacity of the battery cells may result in various different capacities for the battery module 10. The battery cells 12 may be, for example, lithium-ion rechargeable cells, but may be other types of rechargeable cells.

The battery module 10 may include one or more module processors 14 operably connected to the one or more battery cells 12 to obtain performance information from the one or more battery cells 12. In the illustrated embodiment of FIG. 2A, the processor 14 is operably connected to the battery cells 12 via the battery management system (BMS) 16. The BMS 16 may perform oversight of the battery cells 12 including, for example, monitoring parameters (e.g., voltage, current, temperature, etc.), providing battery protection (e.g., overcurrent, short circuit, over-temperature, etc.), preventing operation outside a battery cell's ratings, estimating a battery cell's operational state, continually optimizing battery performance, reporting operational status to the processor 14, etc. The processor 14 is operably connected to the BMS 16 to obtain the performance information of the battery cells 12. Performance information in this context includes all information the BMS 16 may obtain from the battery module 10 including the battery cells 12 including, for example, voltage, current, temperature, abnormal conditions such as overcurrent, short circuit, over-temperature, battery cell's operational state, etc.

The battery module 10 may also include a wireless transceiver 18 operably connected to the processor 14 to remotely transmit data including the performance information from the battery cells 12. The wireless transceiver 18 may include a transmitter, a receiver, or both and, thus, it may exclusively transmit information, exclusively receive information, or it may transmit and receive information. The wireless transceiver 18 may be a broadband cellular network (e.g., 3G, 4G, 5G, etc.) transceiver or a transceiver employing other local area network (LAN) or wide area network (WAN) technologies. The wireless transceiver 18 may, for example, communicate in a network using Wi-Fi, Bluetooth, satellite communication, etc.

As best illustrated in FIG. 2B, the battery module 10 may also include an enclosure 20 at least partially enclosing the one or more battery cells 12, the one or more module processors 14, and the wireless transceiver 18. The enclosure 20 may have mounted to or built thereupon one or more handles 22 for a user to grab to transport the module 10. The weight, size, and form factor of the module 10 is designed with ergonomics in mind to be “human-sized.” That is, the module 10 may be designed to be transportable by a single person: of such size, shape, and weight that a single person may carry it relatively comfortably and without injury.

Regarding weight, the module may be designed to comply with maximum lifting weight regulations or guidelines such as, for example, the Revised National Institute of Occupational Safety and Health (NIOSH) Lifting Equation (2021), guidelines for evaluating two-handed manual lifting tasks.

Regarding size and form factor, the module 10 may be designed to have a generally “suit case” rectangular form factor with the handle 22 installed or built thereupon at one end of the module 10. The dimensions of the module 10 may be height in the range of 12 inches to 24 inches, width in the range of 6 inches to 12 inches, and depth in the range of 4 inches to 8 inches. In one embodiment, the module 10 may be 16 inches tall, 9.5 inches wide, and 5.5 inches deep. In some embodiments, the battery module 10 is designed with height in a range shorter than 12 inches or taller than 24 inches, width in a range narrower than 6 inches or wider than 12 inches, and depth in a range shallower than 4 inches or deeper than 8 inches.

Returning to FIG. 2A, the module 10 may include a power port 24 for connecting the battery module 10 to a powered device PD. The powered device PD may correspond to a vehicle, a home appliance, etc. as described in detail below. The power port 24 may also serve as a recharge port for the battery module 10. That is, since the battery module 10 is removable and transportable, a user may plug in the power port 24 of the battery module 10 in, for example, a vehicle's power port to power the vehicle, remove the battery module 10 from the vehicle, transport the battery module 10 to a charging station, and plug the battery module 10 to the charging station to be charged via the power port 24.

The battery module 10 may also include a data port 26 to connect the battery module 10 to a data buss of the powered device PD. For example, if the powered device PD is a vehicle, the data port 26 may be connected to a CAN bus (ISO 11898 Standard) of the vehicle. Similarly, the data port 26 may be connected to other communications systems such as, for example, wired standard (RS485, etc.) as well as wireless standard (Wi-Fi, Bluetooth, ZigBee, WiMax, etc.) communications systems. Thus, the data port 26 may be wired port, a wireless port, or combinations thereof.

As best shown in FIG. 2C, the battery module 10 may have a connector 11 to plug in to a connector 15 of a base 13. The connector 11 may incorporate the power port 24 and data port 26. The base 13 may be a stand-alone charging/power distribution port connected to a building's power distribution system. The base 13 may also be a vehicle battery dock or receiver for the vehicle PD-V.

The battery module 10 may also include a global position system (GPS) 28 receiver operably connected to the processor 14 to communicate to the processor 14 a geographical location of the battery module 10. In some embodiments, the battery module 10 may employ techniques (e.g., Bluetooth communication with GPS-equipped mobile phone CD, Wi-Fi Positioning System (WPS), etc.) instead of or in addition to the to the GPS 28 to obtain the geographical location of the battery module 10.

Returning to FIG. 1, the GF system includes a constellation of battery modules 10.

Some battery modules 10 may be connected to vehicles PD-V to power the vehicles, to serve as one-way or two-way vehicle wireless data transmission devices, and to serve as the vehicles' link to the IoT. The battery module 10 power capacity allows for powering of the electric vehicle PD-V via the power port 24. The BMS 16 of the battery module may also allow for the collection of vehicle and battery performance data. The GPS 28 may be used to obtain location data of the vehicle PD-V and whether the battery module 10 (and hence the vehicle PD-V) is stationary or moving, etc. The battery module 10 may also be connected to a vehicle data system of the electric vehicle PD-V via the data port 26. The wireless transmitter 18 of the battery module 10 may transmit the collected data via the cloud CL to be stored in a database 30.

The system 1 may also include a remote server 32 that communicates with the battery modules 10 or the database 30 including receiving the data including the performance information, time of day, live traffic conditions, or other information. That is, the battery modules 10 may use their wireless transceiver 18 to communicate the data including the performance information to the cloud CL and the server 30, also connected to the cloud CL, may receive the data including the performance information, time of day, live traffic conditions, or other information either directly from the battery modules 10 or from the database 30.

The system 1 uses the GPS 28 (or any other known technique) to determine the geographical location of the electric vehicle PD-V and uses the geographical location, for example, to select an electric vehicle performance/ride setting from a plurality of electric vehicle performance settings. The plurality of electric vehicle performance settings may correspond to the US Federal Motor Vehicle Safety Standards controlled by the Department of Transportation (FMVSS) and/or may include user preferences and user-history based on the determined geographical location and/or time of day. The FMVSS safety standards may include type 1 or 2 e-Bicycle, moped, or motorcycle. Different jurisdictions may require different safety or performance standards for a vehicle to have one the four classes.

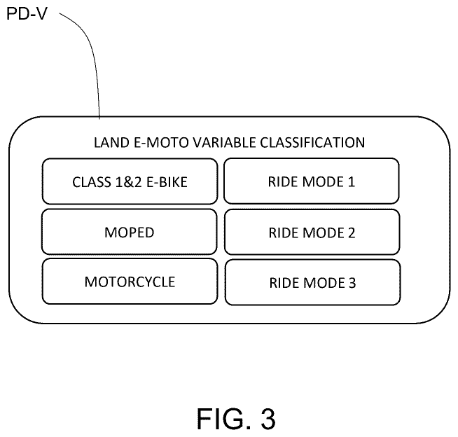

FIG. 3 illustrates a simplified view of a potential display for the system 1. The electric vehicle PD-V may include a digital display that displays a current performance/ride setting as selected by the system 1 based on the geographical location of the electric vehicle PD-V as determined by the battery module 10.

In one embodiment, the battery module 10 and specifically the processor 14 or the BMS 16 may have stored therein or in associated storage or memory a database with the various ride mode rules correlated to geographical locations, time of day, live traffic conditions, and/or user history. In this embodiment, the remote server 32 may maintain the ride mode database of the battery module 10 up to date (e.g., in case a jurisdiction changes its rules) by sending over-the-air (OTA) updates to the battery module 10 via the wireless transceiver 18. A battery module 10 or specifically the processor 14 or the BMS 16 detects geographical location of the vehicle PD-V to which it is connected, looks up in the database a corresponding riding mode for the geographical location, time of day, live traffic conditions, and/or user history, and controls the vehicle PD-V to which it is connected to perform in the corresponding ride mode or at least communicates the information to the vehicle PD-V so it may set the proper ride mode for the geographical location, time of day, live traffic conditions, and/or user history. The OTA updates are dynamic, live rule fetching based on events or emergencies, adapting in real-time to any changes or updates in the rules for any given jurisdiction or boundary. For example, if a given jurisdiction temporarily issues a ban on vehicles above 500 W or sets a certain speed limit for an event or certain time period in that jurisdiction, the remote server 32 will immediately send an OTA update to the battery module 10 to adapt the ride mode to such ban or conditions.

In another embodiment, the database 30 may have stored therein or in associated storage or memory the various ride mode rules correlated to geographical locations, time of day, live traffic conditions, and/or user history. In this embodiment, the remote server 32 may maintain the ride mode rule information in the database 30 up to date (e.g., in case a jurisdiction changes its rules). A battery module 10 or specifically the processor 14 or the BMS 16 detects geographical location of the vehicle PD-V to which it is connected and transmits the location to the remote server 32 via the wireless transceiver 18. The remote server 32 may look up in the database 30 a corresponding riding mode for the geographical location, time of day, live traffic conditions, and/or user history, and communicate to the battery module 10 via the wireless transceiver 18. The battery module 10 or specifically the processor 14 may control the vehicle PD-V to which it is connected to perform in the corresponding ride mode or at least communicate the information to the vehicle PD-V so it may set the proper ride mode for the geographical location, time of day, live traffic conditions, and/or user history.

If the newly determined ride mode is different from the currently set ride mode, the processor 14 may automatically alter the vehicle performance parameters to match the selected electric vehicle performance setting. In one embodiment, the processor 14 may delay until the electric vehicle PD-V comes to a stop to update the ride mode parameters.

For example, in FIG. 1, a rider may ride the vehicle PD-V from the state of Minnesota to the state of Wisconsin, which as of the time of this disclosure have different rules applying to LEV. Immediately prior to entering Wisconsin, the vehicle PD-V was performing in a ride mode corresponding to the state of Minnesota. The battery module 10 or specifically the processor 14 or the BMS 16 detects location of the vehicle PD-V (from the GPS 28) as Wisconsin. The battery module 10 transmits the location to the remote server 32 via the wireless transceiver 18. The remote server 32 may look up in the database 30 a corresponding riding mode for Wisconsin and communicate to the battery module 10 via the wireless transceiver 18. The battery module 10 or specifically the processor 14 may control the vehicle PD-V to which it is connected to perform in the corresponding ride mode for Wisconsin or at least communicate the information to the vehicle PD-V so it may set the proper ride mode for the new location. The same process applies to user predefined boundary lines M2 as to state-line or other jurisdictional boundary lines M1.

For manufacturers, a vehicle PD-V may be transported anywhere after manufacturing. At the point of sale or first use, the battery module 10 or specifically the processor 14 or the BMS 16 detects location of the vehicle PD-V (from the GPS 28). The battery module 10 transmits the location to the remote server 32 via the wireless transceiver 18. The remote server 32 may look up in the database 30 a corresponding riding mode for the geographical location, time of day, live traffic conditions, and/or user history and communicate to the battery module 10 via the wireless transceiver 18. The battery module 10 or specifically the processor 14 may control the vehicle PD-V to which it is connected to perform in the corresponding ride mode for the location or at least communicate the information to the vehicle PD-V so it may set the proper ride mode for the location, time of day, live traffic conditions, and/or user history.

In some circumstances a given electric vehicle PD-V may be determined to comply with regulations corresponding to multiple ride modes and, therefore, the electric vehicle PD-V may be set to perform in multiple ride modes. In the embodiment of FIG. 3, the display may also be a user input interface configured for a user to select from available ride modes. The user input interface may indicate ride modes that are available for selection by the user based on the location of the electric vehicle PD-V. The user input interface may receive user input including the selection of the electric vehicle ride mode from the available ride modes.

The battery module 10 may be configured to communicate with a mobile device CD via, for example, the wireless transceiver 18. The mobile device CD may further include a user input interface (e.g., an app) configured to indicate a set of electric vehicle performance settings including ride modes currently available for selection by the user based on the location of the electric vehicle PD-V. The user input interface of the mobile device CD may be configured to receive user input selection of the desired electric vehicle performance settings from the set of performance settings. The user may then use the user interface of the mobile device CD to select the desired performance setting including a ride mode.

The one or more processors 14 may prevent a user from selecting an electric vehicle performance setting such as a ride mode that is not currently available for selection by the user based on the location of the electric vehicle.

These and other scenarios are possible because of the capabilities of the battery-centric Geo-Fenced (GF) Ride Control system of the present disclosure.

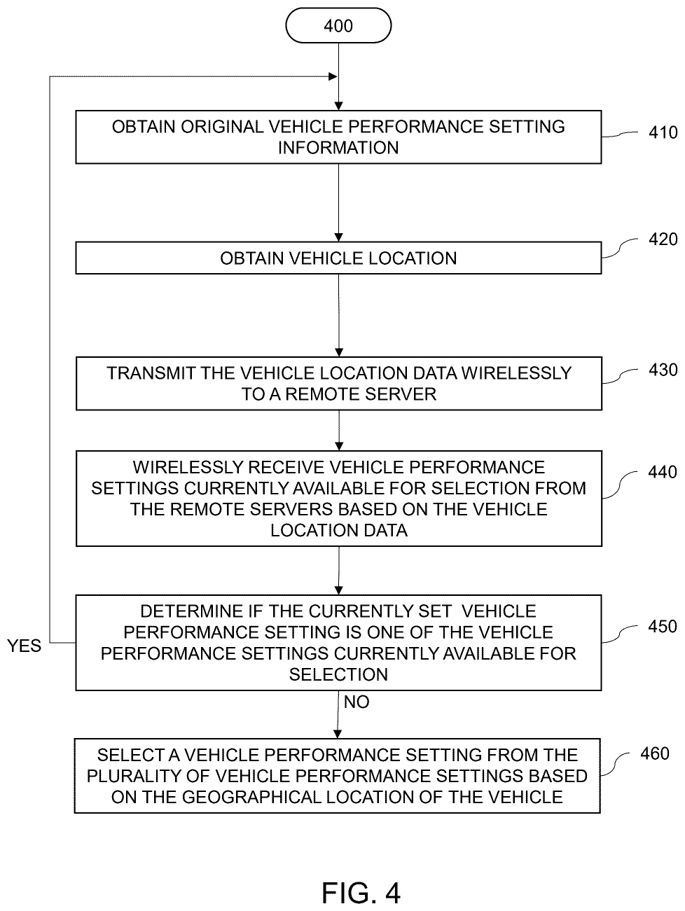

Exemplary methods may be better appreciated with reference to the flow diagram of FIG. 4. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an exemplary methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art or artificial intelligence (AI) may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence or machine learning techniques.

FIG. 4 illustrates a flow diagram for an exemplary method 400 for a battery-centric Geo-Fenced Ride Control (GF) system. At 410, the method 400 includes obtaining original vehicle performance setting information. At 420, the method 400 includes obtaining vehicle location. At 430, the method 400 includes transmitting the vehicle location data wirelessly to a remote sever. At 440, the method 400 includes wirelessly receiving vehicle performance settings currently available for selection from the remote servers based on the vehicle location data, time of day, live traffic conditions, and/or user history. At 450, the method 400 may include comparing the vehicle performance settings currently available for selection with the currently set vehicle performance settings. If the currently set vehicle performance setting is one of the vehicle performance settings currently available for selection, then the method restarts. If the currently set vehicle performance setting is not one of the vehicle performance settings currently available for selection, then at 460 the method includes selecting a vehicle performance setting from the plurality of vehicle performance settings based on the geographical location and/or time of day of the vehicle.

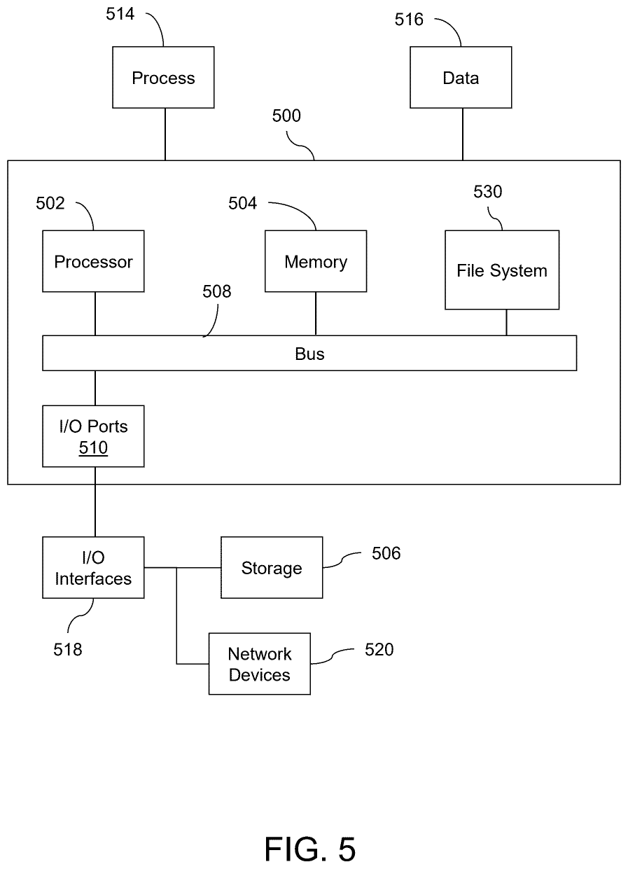

FIG. 5 illustrates a block diagram of an exemplary computing environment 500 that may be used to deploy the battery module 10 or the remote server 32 of the present disclosure. The environment 500 includes a processor 502 (e.g., the processor 14), a memory 504, and I/O Ports 510 operably connected by a bus 508. The environment 500 may also include the database 30 or may communicate with the database 30 via the cloud CL.

The processor 502 (e.g., the processor 14) can be a variety of various processors including dual microprocessor and other multi-processor architectures. The memory 504 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A storage 506 may be operably connected to the environment 500 via, for example, an I/O Interfaces (e.g., card, device) 518 and an I/O Ports 510. The storage 506 can include, but is not limited to, devices like a magnetic disk drive, a solid state disk drive, a floppy disk drive, a tape drive, a Zip drive, a flash memory card, or a memory stick. Furthermore, the storage 506 can include optical drives like a CD-ROM, a CD recordable drive (CD-R drive), a CD rewriteable drive (CD-RW drive), or a digital video ROM drive (DVD ROM). The memory 504 can store processes 514 or data 516, for example. The storage 506 or memory 504 can store an operating system that controls and allocates resources of the environment 500. The database 30 may reside in the storage 506.

The bus 508 can be a single internal bus interconnect architecture or other bus or mesh architectures. While a single bus is illustrated, it is to be appreciated that environment 500 may communicate with various devices, logics, and peripherals using other busses that are not illustrated (e.g., PCIE, SATA, Infiniband, 1394, USB, Ethernet). The bus 508 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The environment 500 may interact with input/output devices via I/O Interfaces 518 and I/O Ports 510. Input/output devices can include, but are not limited to, a keyboard, a microphone, a pointing and selection device, cameras, video cards, displays, storage 506, network devices 520, and the like. The I/O Ports 510 can include but are not limited to, serial ports, parallel ports, and USB ports.

The environment 500 (and the battery module 10) can operate in a network environment and thus may be connected to network devices 520 via the I/O Interfaces 518, or the I/O Ports 510. Through the network devices 520, the environment 500 may interact with a network. Through the network, the environment 500 may be logically connected to remote computers including, for example, a network computer or file server hosting the database 30. The networks with which the environment 500 may interact include, but are not limited to, a local area network (LAN), a wide area network (WAN), and other networks. The network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 520 can connect to WAN technologies including, but not limited to, point to point links, circuit switching networks like integrated services digital networks (ISDN), packet switching networks, satellite communication, and digital subscriber lines (DSL). While individual network types are described, it is to be appreciated that communications via, over, or through a network may include combinations and mixtures of communications.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A two wheel vehicle comprising:
one or more battery modules including one or more battery cells;
one or more processors operably connected to the one or more battery cells to control two wheel vehicle performance;
a Global Positioning System (GPS) configured to determine a geographical location of the two wheel vehicle; and
a wireless transceiver operably connected to the one or more processors to receive data from a remote server including time of day or live traffic conditions;
the one or more processors configured to select a two wheel vehicle performance setting from a plurality of two wheel vehicle performance settings based on at least two of the geographical location of the two wheel vehicle, the time of day, or the live traffic conditions.

2. The two wheel vehicle of claim 1, wherein the plurality of two wheel vehicle performance settings correspond to US Federal Motor Vehicle Safety Standards (FMVSS) including type 1 or 2 e-Bicycle, moped, or motorcycle.

3. The two wheel vehicle of claim 1, wherein the wireless transceiver includes:
a wireless transmitter operably connected to the one or more processors and configured to transmit data wirelessly including location of the vehicle to a remote server; and
a wireless receiver operably connected to the one or more processors to receive data from the remote server including vehicle performance parameters, the processor configured to select the two wheel vehicle performance setting from the plurality of two wheel vehicle performance settings based on the vehicle performance parameters.

4. The two wheel vehicle of claim 1, comprising a user input interface configured to receive user input including selection of the two wheel vehicle performance setting from the plurality of two wheel vehicle performance settings.

5. The two wheel vehicle of claim 1, comprising a user input interface configured to indicate the selected two wheel vehicle performance setting from the plurality of two wheel vehicle performance settings.

6. The two wheel vehicle of claim 1, comprising a user input interface configured to indicate a set of two wheel vehicle performance settings from the plurality of two wheel vehicle performance settings currently available for selection by the user based on the location of the two wheel vehicle, the user input interface configured to receive user input including selection of a two wheel vehicle performance setting from the set of two wheel vehicle performance settings.

7. The two wheel vehicle of claim 1, the one or more processors configured to communicate with a mobile device including a user input interface configured to indicate a set of two wheel vehicle performance settings from the plurality of two wheel vehicle performance settings currently available for selection by the user based on the location of the two wheel vehicle, the user input interface configured to receive user input including selection of a two wheel vehicle performance setting from the set of two wheel vehicle performance settings, the one or more processors configured to receiver the user input and select the two wheel vehicle performance setting from the set of two wheel vehicle performance settings based on the user input.

8. The two wheel vehicle of claim 1, wherein the one or more processors prevent a user from selecting a two wheel vehicle performance setting from the plurality of two wheel vehicle performance settings not currently available for selection by the user based on the location of the two wheel vehicle.

9. A vehicle comprising:
one or more battery modules including one or more battery cells;
one or more processors operably connected to the one or more battery cells to control vehicle performance; and
a location information receiver configured to receive geographical location of the vehicle;
a wireless transceiver operably connected to the one or more processors to receive data from a remote server including time of day or live traffic conditions;
the one or more processors configured to select a vehicle performance setting from a plurality of vehicle performance settings based on at least two of the geographical location of the vehicle, the time of day, or the live traffic conditions.

10. The vehicle of claim 9, wherein the plurality of vehicle performance settings corresponds to US Federal Motor Vehicle Safety Standards (FMVSS) including type 1 or 2 e-Bicycle, moped, or vehicle.

11. The vehicle of claim 9, wherein the wireless transceiver includes:
a wireless transmitter operably connected to the one or more processors and configured to transmit data wirelessly including location of the vehicle to a remote server;
a wireless receiver operably connected to the one or more processors to receive data from the remote server including vehicle performance parameters, the processor configured to select the vehicle performance setting from the plurality of vehicle performance settings based on the vehicle performance parameters.

12. The vehicle of claim 9, comprising a user input interface configured to receive user input including selection of the vehicle performance setting from the plurality of vehicle performance settings.

13. The vehicle of claim 9, comprising a user input interface configured to indicate the selected vehicle performance setting from the plurality of vehicle performance settings.

14. The vehicle of claim 9, comprising a user input interface configured to indicate a set of vehicle performance settings from the plurality of vehicle performance settings currently available for selection by the user based on the location of the vehicle, the user input interface configured to receive user input including selection of a vehicle performance setting from the set of vehicle performance settings.

15. The vehicle of claim 9, the one or more processors configured to communicate with a mobile device including a user input interface configured to indicate a set of vehicle performance settings from the plurality of vehicle performance settings currently available for selection by the user based on the location of the vehicle, the user input interface configured to receive user input including selection of a vehicle performance setting from the set of vehicle performance settings, the one or more processors configured to receiver the user input and select the vehicle performance setting from the set of vehicle performance settings based on the user input.

16. The vehicle of claim 9, wherein the one or more processors prevent a user from selecting a vehicle performance setting from the plurality of vehicle performance settings not currently available for selection by the user based on the location of the vehicle.

17. A method of controlling a vehicle, comprising:
providing at least two of a geographical location of the vehicle, a time of day, and live traffic conditions; and
selecting a vehicle performance setting from a plurality of vehicle performance settings based on the at least two of the geographical location of the vehicle, the time of day, and the live traffic conditions.

18. The method of claim 17, comprising:
the vehicle transmitting data wirelessly including location of the vehicle to a remote server;
the vehicle receiving data from the remote server including the time of day, the live traffic conditions, and the plurality of vehicle performance parameters; and
selecting the vehicle performance setting from the plurality of vehicle performance settings based on the vehicle performance parameters.

19. The method of claim 17, comprising:
indicating to a rider of the vehicle a set of vehicle performance settings from the plurality of vehicle performance settings currently available for selection by the rider based on the location of the vehicle; and
receiving user input from the rider including selection of a vehicle performance setting from the set of vehicle performance settings.

20. The method of claim 17, comprising:
preventing a user from selecting a vehicle performance setting from the plurality of vehicle performance settings not currently available for selection by the user based on the location of the vehicle.
